(19) United States
(12) Patent Application Publication
(10) Pub. No.: US 2024/0273419 A1
(43) Pub. Date: Aug. 15, 2024

(54) APPROACHES TO DYNAMICALLY ORGANIZING TIME-VARYING INFORMATION INTO MULTI-DIMENSIONAL VISUALIZATIONS

(71) Applicant: Tyler PEPPEL, Belvedere, CA (US)

(72) Inventor: Tyler PEPPEL, Belvedere, CA (US)

(21) Appl. No.: 18/648,266

(22) Filed: Apr. 26, 2024

Related U.S. Application Data
(62) Division of application No. 15/881,628, filed on Jan. 26, 2018, now Pat. No. 11,977,994.
Application No. 15/881,628 is a continuation of application No. 13/338,170, filed on Dec. 27, 2011, now Pat. No. 9,881,257.
(60) Provisional application No. 61/427,961, filed on Dec. 29, 2010.

(51) Int. Cl. G06Q 10/00; G06F 3/0484; G06F 16/9032; G06F 16/9038

(52) U.S. Cl. CPC G06Q 10/00; G06F 3/0484; G06F 16/90328; G06F 16/9038; G06F 2203/04806

(57) ABSTRACT

Various kinds of business and other information are tracked in real time. A coherent information visualization, for example as a time line, automatically, simultaneously presents relevant information to a user across multiple dimensions. Tools are provided that allow the user to establish and manipulate multi-dimensional linkages to develop insights into information gathered from multiple domains.

### CROSS REFERENCE TO RELATED APPLICATIONS

This application is a divisional of U.S. patent application Ser. No. 15/881,628, filed Jan. 26, 2018, which is a continuation of U.S. patent application Ser. No. 13/338,170, filed on Dec. 27, 2011, now U.S. Pat. No. 9,881,257, issued Jan. 30, 2019, which claims priority to U.S. Provisional Patent Application No. 61/427,961, filed on Dec. 29, 2010, each of which is incorporated by reference herein in its entirety.

### BACKGROUND OF THE INVENTION

### Technical Field

The invention relates to the organization, presentation, and use of information. More particularly, the invention relates to multi-dimensional visualization of temporal information.

### Description of the Background Art

The field of information visualization has emerged “from research in human-computer interaction, computer science, graphics, visual design, psychology, and business methods. It is increasingly applied as a critical component in scientific research, digital libraries, data mining, financial data analysis, market studies, manufacturing production control, and drug discovery.” See, Benjamin B. Bederson and Ben Shneiderman (2003); The Craft of Information Visualization: Readings and Reflections, Morgan Kaufmann ISBN 1-55860-915-6.

Information visualization presumes that “visual representations and interaction techniques take advantage of the human eye's broad bandwidth pathway into the mind to allow users to see, explore, and understand large amounts of information at once. Information visualization is focused on the creation of approaches for conveying abstract information in intuitive ways.” See, James J. Thomas and Kristin A. Cook (Ed.) (2005); Illuminating the Path: The R&D Agenda for Visual Analytics, National Visualization and Analytics Center. p.30.

Information visualization insights are being applied in areas such as, scientific research, digital libraries, data mining, financial data analysis, market studies, manufacturing production control, and crime mapping.

There is a vast and rapidly growing amount of time-based data available on networks, but no simple, standard way of viewing, sharing, and presenting it. State of the art information visualization is relatively unsophisticated in connection with such multi-dimensional, temporal information. Further, state of the art information visualization is relatively static, lacking both the ability to provide real time information transforms and the ability to establish and manipulate multi-dimensional linkages to develop insights into information gathered from multiple domains.

### SUMMARY OF THE INVENTION

An embodiment of the invention addresses that fact that there is a large amount of information available to individuals and organizations that could be valuable if it were organized in a useful way. Heretofore, there has not been a simple way to track and organize this information. Embodiments of the invention present a new way to track all kinds of business and other information in real time. An embodiment of the invention provides a coherent information visualization, for example as a time line, that automatically, simultaneously presents relevant information to a user across multiple dimensions. An embodiment of the invention provides tools that allow the user to establish and manipulate multi-dimensional linkages to develop insights into information gathered from multiple domains.

### BRIEF DESCRIPTION OF THE DRAWINGS

FIG. 1 is a schematic representation of a display showing a multi-dimensional visualization of temporal information according to the invention;

FIG. 2 is a schematic representation of a display showing sources of information for multi-dimensional visualization of temporal information according to the invention;

FIG. 3 is a schematic representation of a strip according to the invention;

FIG. 4 is a schematic representation showing that preconfigured strips can be selected from a library according to the invention;

FIG. 5 is a schematic representation showing that strips can be combined together on dynamic screens according to the invention;

FIG. 6 is a schematic representation that shows a white line which represents a target data threshold according to the invention;

FIG. 7 is a schematic representation that shows incident tracking according to the invention;

FIG. 8 is a schematic representation that shows elected features which include share, print, settings, and help buttons; sliders that control a graph vs. image display proportion; a target level to show performance at a glance; and a “See More” button that shows additional events from a selected time period, according to the invention;

FIG. 9 is a schematic representation of a use case for enterprise metrics and reporting according to the invention;

FIG. 10 is a schematic representation of a use case for company-related Web analytics according to the invention;

FIG. 11 is a schematic representation of a use case for company-related activity from public data sources according to the invention;

FIG. 12 is a schematic representation that shows dynamic screens of strips grouped under tabs according to the invention;

FIG. 13 is a schematic representation that shows navigation according to the invention;

FIG. 14 is a schematic representation that shows that strips are cross platform according to the invention;

FIGS. 15 and 16 are schematic representations of a widget window according to the invention;

FIG. 17 is a schematic representation that shows user settings for strips according to the invention;

FIG. 18 is a schematic representation of a user dialog for the creation of a strip according to the invention;

FIG. 19 is a schematic representation that shows user settings for strips according to the invention;

FIG. 20 is a schematic representation that shows user settings for adding a filter to a strip according to the invention;

FIG. 21 is a schematic representation that shows user settings for strips according to the invention;

FIG. 22 is a block schematic diagram of an architecture for implementing a presently preferred embodiment of the invention;

FIG. 23 is a more detailed detail block schematic diagram of an architecture for implementing a presently preferred embodiment of the invention; and

FIG. 24 is a block schematic diagram of a machine in the exemplary form of a computer system within which a set of instructions for causing the machine to perform any one of the herein disclosed methodologies may be executed.

### DETAILED DESCRIPTION OF THE INVENTION

An embodiment of the invention addresses that fact that there is a large amount of information available to individuals and organizations that could be valuable if it were organized in a useful way. Heretofore, there has not been a simple way to track and organize this information. Embodiments of the invention present a new way to track all kinds of business and other information in real time. An embodiment of the invention provides a coherent information visualization, for example as a time line, that automatically, simultaneously presents relevant information to a user across multiple dimensions and from multiple domains. An embodiment of the invention provides tools that allow the user to establish and manipulate multi-dimensional linkages to develop insights into information gathered from multiple domains.

### Terminology

For purposes of the discussion herein, the following terms shall have their accompanying meanings:

A strip is a single timeline.

A strip page is a unique URL containing one or more strips.

A strip tab is a subset of a strip page that contains one or more strips.

A source is a strip data source.

A topic is a subject of interest to a strip user.

A filter filters a data source.

A strip template is a container for data in which no sources, topics, or filters are defined.

A strip developer is a person or entity that uses the strip API to create custom strip configurations.

A widget window provides alternate ways, e.g. a non-timeline metaphor, for displaying strip source data, for example, a world map.

### DISCUSSION

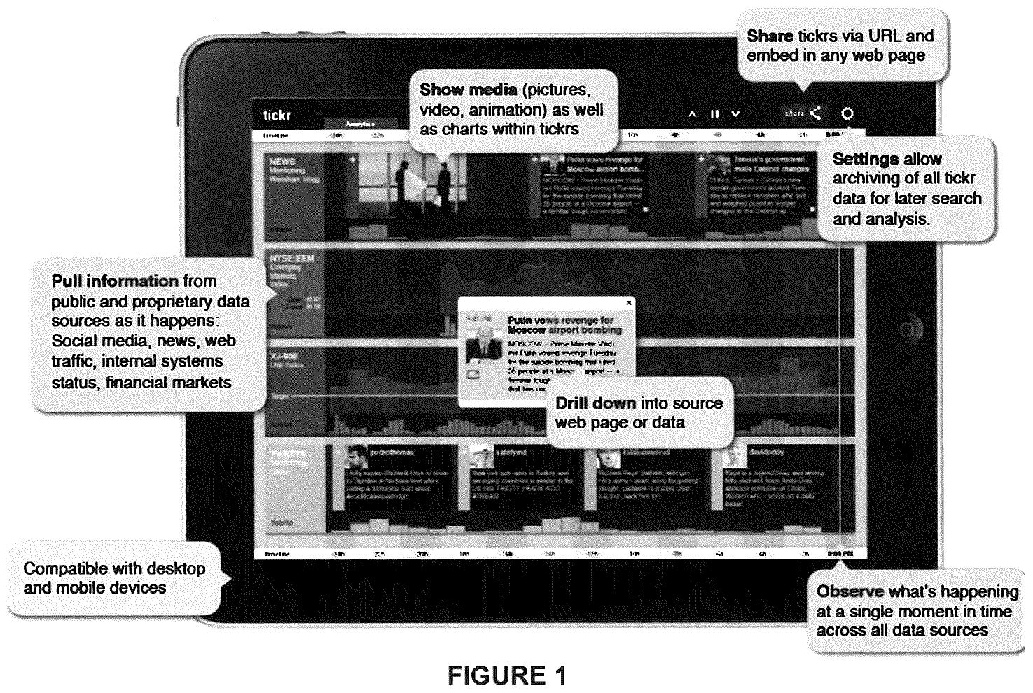

FIG. 1 is a schematic representation of a display showing a multi-dimensional visualization of temporal information. In FIG. 1, a series of strips are arranged along a timeline, each strip providing information of a different type and/or from a different source, but related in some useful way to the information in each of the other strips. Key features of this embodiment include the compatibility of the system herein disclosed with any device, the integration of all media within the strip, the ability to drill down in an information source which is the information basis for the strip, the ability to observe what is happening at a selected moment in time across multiple dimensions for comparative analysis (derivative information), as well as the ability to provide a view of such information sources over an extended period of time (integral information), the ability to share displays and to embed them into other data sources, such as Web pages, the provision of a full set of user tools that allow for creation and configuration of strips by non-technical users, as well as archival tools that may be used to save a display for later search and analysis, and the ability to pull information from public and proprietary data sources as it happens, using such sources as social media, news, Web traffic, marketing and advertising campaign activity, internal systems status, and financial market information.

### Strip Creation/Configuration Features

In an embodiment of the invention, two methods are provided for strip creation and configuration: a simple UI, and a programmatic approach (API).

The simple UI approach comprises a library of pre-created links to data sources and a library of pre-created strip templates, where the system matches a template to a data source link. In this embodiment, a user chooses from predefined sources and templates or creates his own strip by such operations as define/name strips, define/name tabs, and define/name dynamic screens. The UI allows the user to set viewing/sharing privileges, set scroll function/scroll rate, set timeline display duration, and set archiving parameters.

The programmatic access/control approach is provided for strip developers to define and configure custom strips. The API allows the user to, for example, create new strip templates, program a widget window, set creation/sharing/viewing privileges, and set-up private hosting.

### Strip Template Types

In an embodiment, strip templates include event timelines, which incorporate, for example, social media (text pictures video animation); news media, such as text, pictures, video, and animation; IT network events, financial transactions, Web traffic/events, including Website activity and ad/marketing campaign tracking; calendar events; and collaboration events, such as project management and real-time messaging.

Strip templates also include graphs, which may comprise any type of time-based graph and/or a combination event timeline/media/+graph.

### Presentation/Publishing

In an embodiment, data sources are harmonized to allow visual and programmatic comparison of data from different data sources at a single moment in time. The invention comprehends a platform-independent, browser-based presentation on desktop and mobile devices (device-independent). Strips can be embedded in other Web pages and/or Web services and can be exported to any desired format, such as PDF, JPEG, and PPT.

### Analysis

An embodiment of the invention organizes strips to compare synchronous events from separate data sources visually or programmatically. This allows analysis with regard to, for example, resource allocation; ROI analysis; analysis of collaborative activity; and impact analysis, for example viewing drought vs. commodity prices. The invention includes a drill-down feature that enables users to click on strips to access more detailed data and/or establish a direct two-way link to the referring data source. The timescale of single/multiple strips can be adjusted in real-time to support analysis/comparison of events from multiple data sources. Further, strips can be scrolled independently, i.e. asynchronously, to compare events from different time periods visually.

### Collaboration

Strips and strip dynamic screens can be shared, subject to sharing privileges, across networks using common Web-based sharing methods, such as emailing a URL. Comments can be attached/embedded on strip timelines. The invention thus comprehends the provision of tools enable a strip user to engage the originator of data via a strip.

### Archiving

Any data displayed in a strip can be archived on the strip server. Such archiving provides the user with the ability to travel back in time in strip timelines and perform visual or programmatic analysis of past events. Archiving also enables travel forward in time to view scheduled future events for visual or programmatic analysis.

### Search

Strip data can be searched using, for example, keywords, data parameters such as patterns and thresholds, and time period.

### Exemplary Embodiment

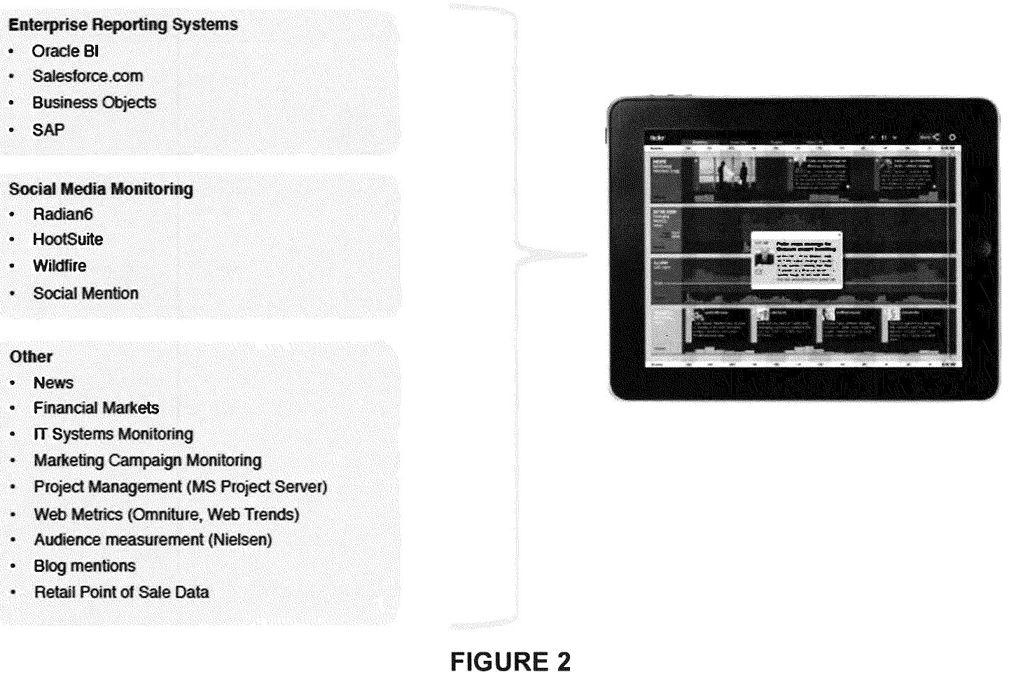

FIG. 2 is a schematic representation of a display showing sources of information for multi-dimensional visualization of temporal information.

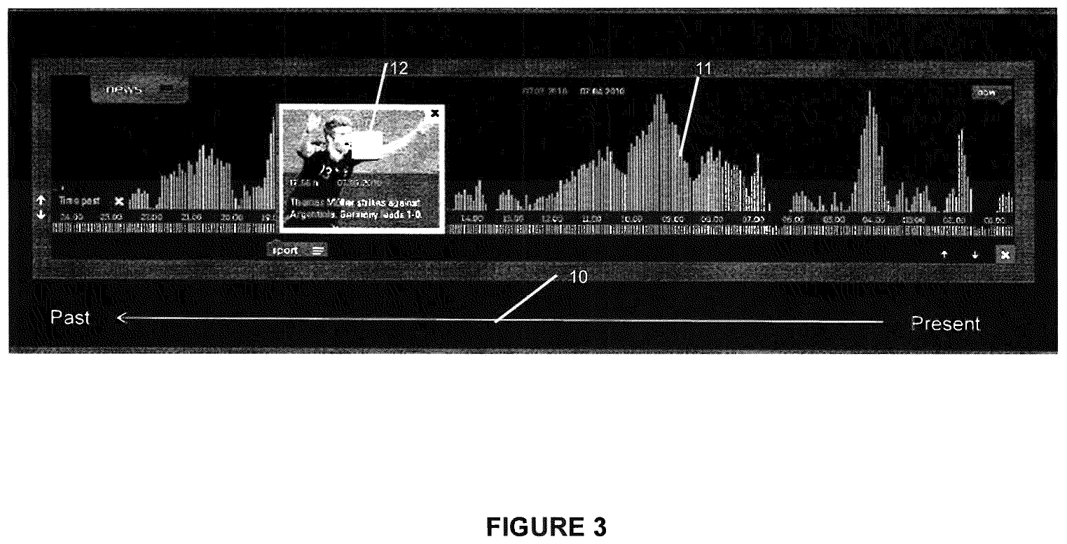

FIG. 3 is a schematic representation of a strip. As discussed above, a strip is a modular format for displaying time-based data. Such data comprehends a variable time period 10. A strip is data source independent, displays such forms of information as graphs 11, pictures 12, video, text, and the like, is dynamically updated, and can be shared as a URL. Media, such as photos, text, audio, and video, can be integrated with quantitative data, shown in FIG. 3 as a graph, in a time-synchronous manner. Examples of strip data sources include (see FIG. 2) proprietary sources, such as business performance analytics, enterprise network activity, customer and audience behaviors, metrics and scorecard outputs, and enterprise data sources, such as Oracle BL, SharePoint, Excel, Salesforce.com data, Cast Iron Systems, and Web Site Analytics; and public sources, such as search engines, news providers, RSS feeds, financial market data, including market activity and sentiment, most popular data, such as entertainment information, postings, and blog entries, and social media, such as Twitter® and Facebook®.

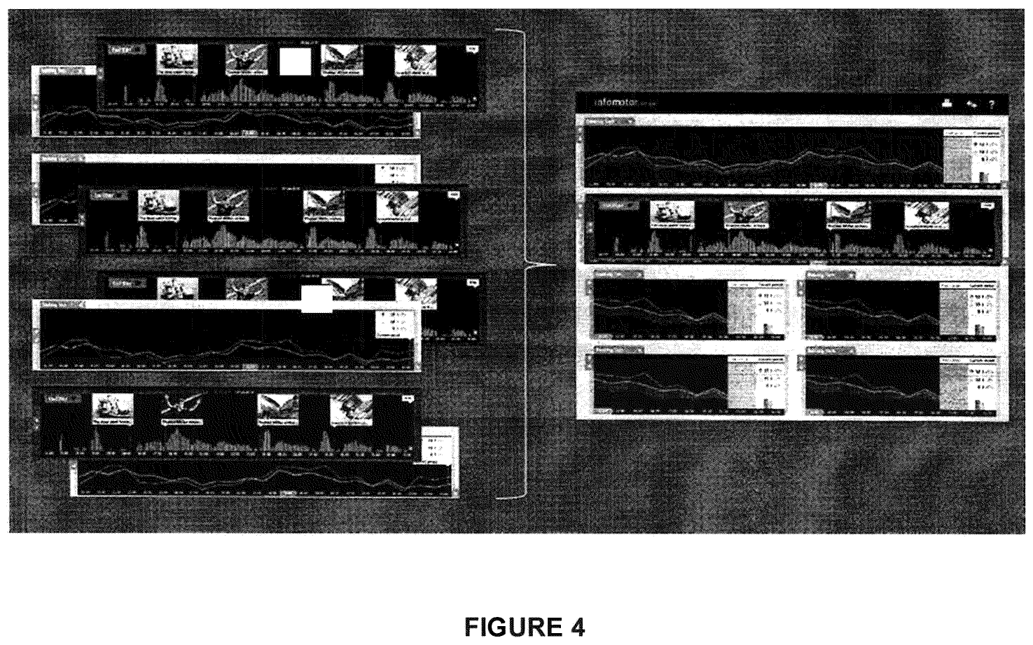

FIG. 4 is a schematic representation showing that preconfigured strips can be selected from a library. In the library environment, a plurality of pre-made strip templates can be combined with a plurality of pre-created data source links. Multiple strips can be nested inside of a summary strip that shows an aggregated view of several strip data sources. For example, 50 US state strips can feed data to one USA summary strip. Further, a function can be applied to data within various strips to produce a resulting derived strip that can be displayed along with the data source strips. Such function can comprise any mathematical functions, Boolean functions, and the like. Strips can also be used to identify causation between events. Thus, this embodiment allows a user to see how an event shown in a first strip affects/causes another event in at least a second strip.

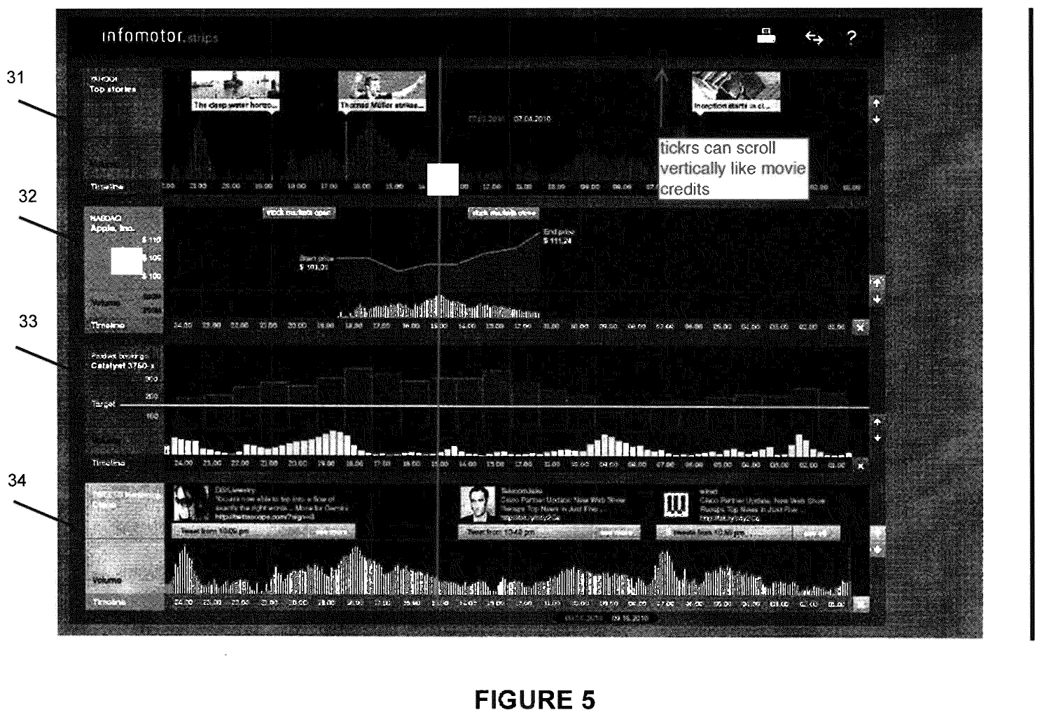

FIG. 5 is a schematic representation showing that strips can be combined together on dynamic screens. Strips can scroll vertically as with movie credits.

Data is harmonized so that data from multiple data sources at a single point in time can be observed and visually or programmatically compared. Left-hand labels 31-34 show topics and sources, as well as data parameters, such as a vertical axis that shows a time scale for a graph.

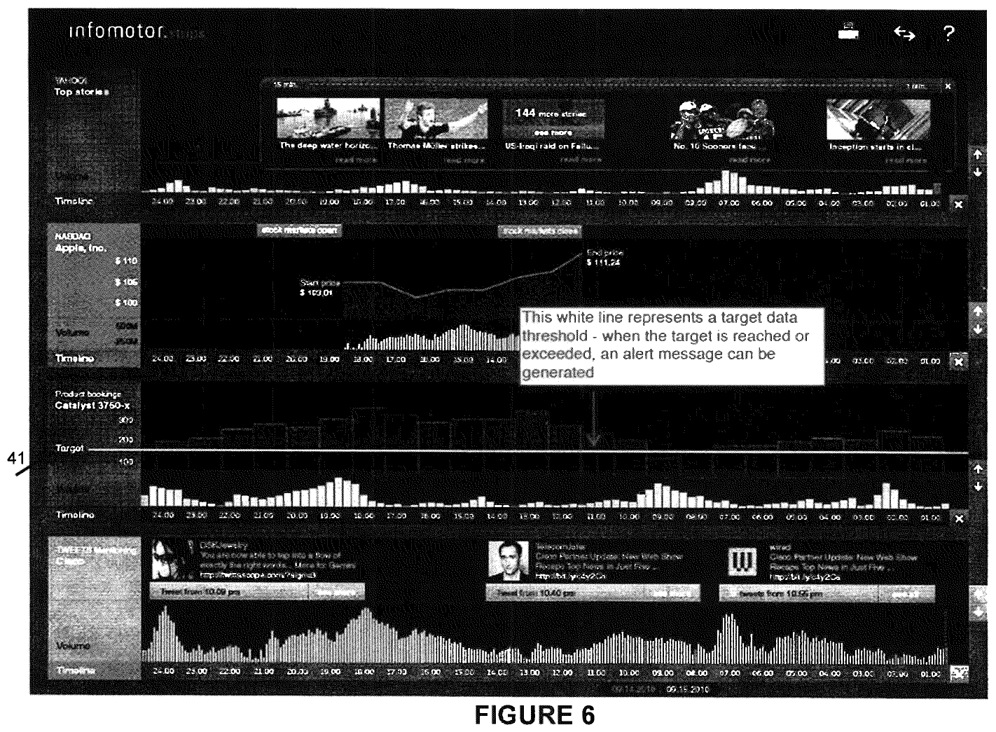

FIG. 6 is a schematic representation that shows a white line 41 which represents a target data threshold. When the target is reached or exceeded, an alert message can be generated. Thus, in an embodiment alerts in the form of notification messages are automatically dispatched when a target threshold is reached or exceeded. These messages may be addressed to humans or to machines. In the case of machines, an alert message may trigger a machine event. A summary data panel 42 shows current values compared with a selected moment from the past.

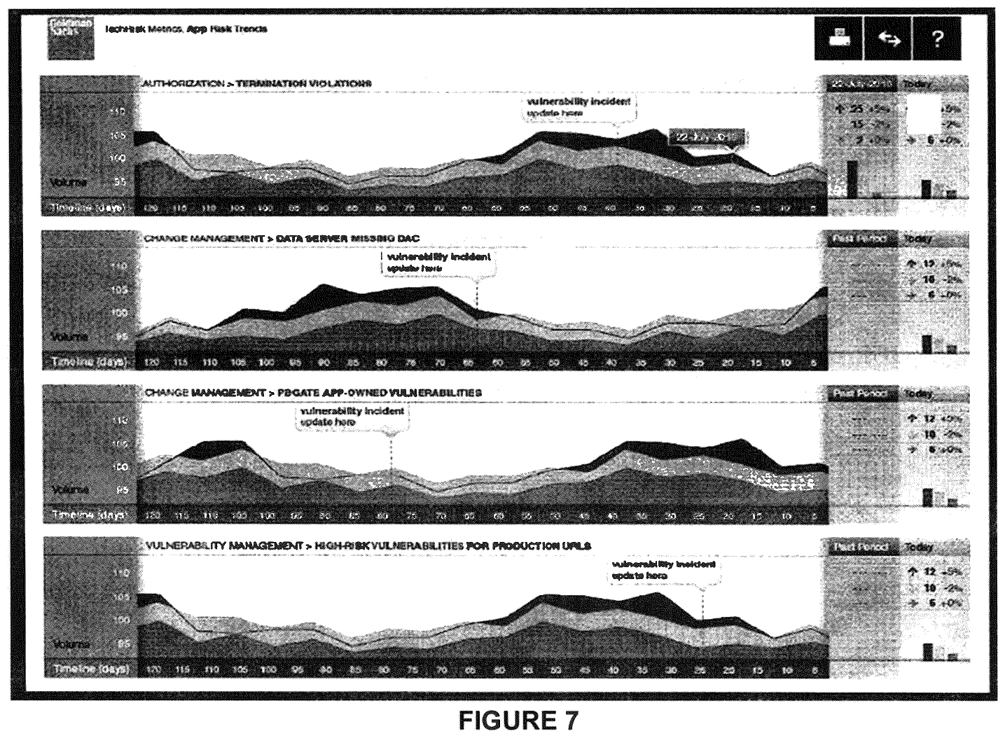

FIG. 7 is a schematic representation that shows incident tracking. As shown in FIG. 7, a page of graph strips enables quick visual comparison of the behavior of multiple data sources.

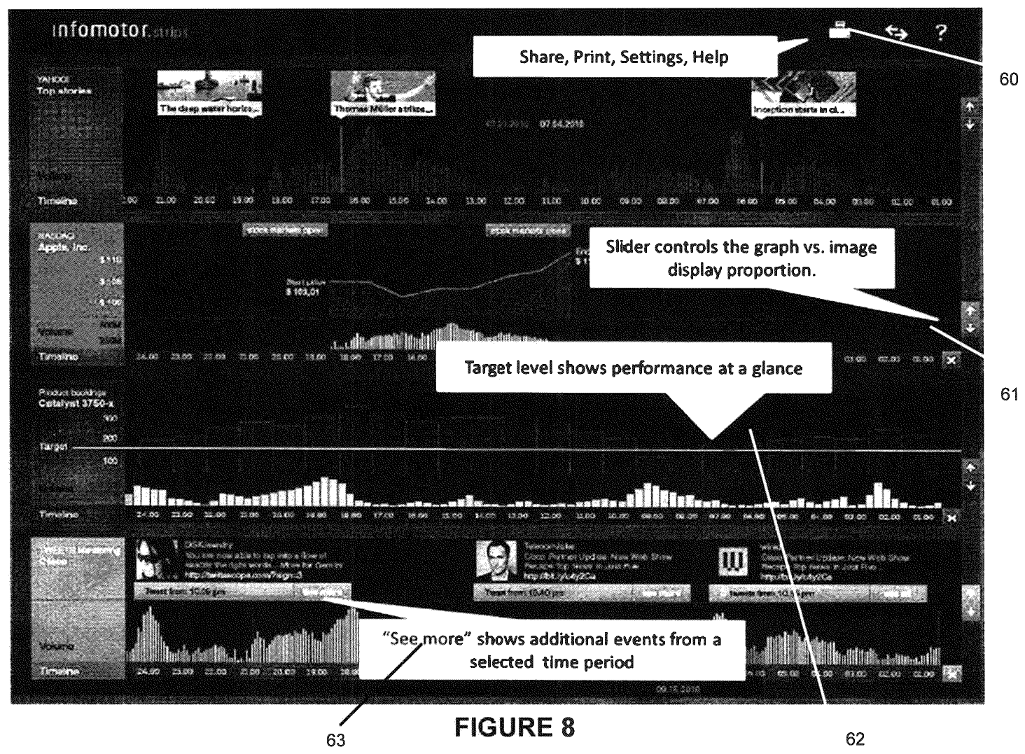

FIG. 8 is a schematic representation that shows selected features which include share, print, settings, and help buttons 60; sliders that control a graph vs. image display proportion 61; a target level to show performance at a glance 62; and a “See More” button 63 that shows additional events from a selected time period.

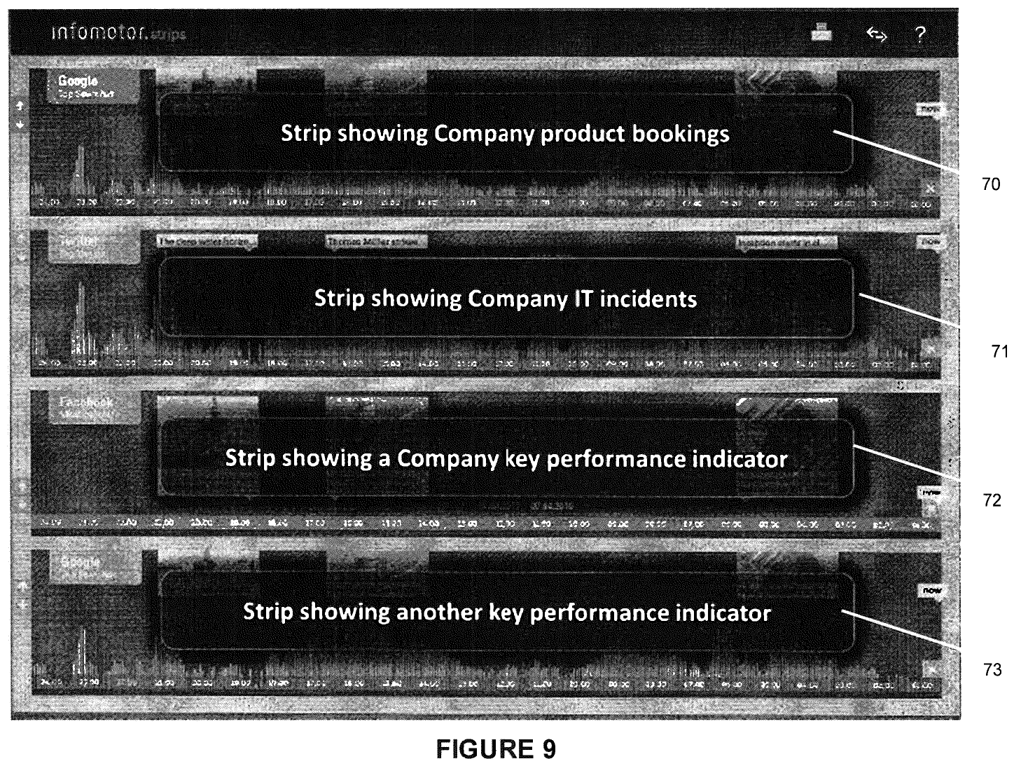

FIGS. 9-11 show various use cases for embodiments of the invention. These figures are provided as examples only. Many other uses are possible with the invention and the use cases shown in FIGS. 9-11 should not be considered limiting to the scope of the invention in any way.

FIG. 9 is a schematic representation of a use case for enterprise metrics and reporting. In FIG. 9, strips are provided that show company bookings 70, company IT incidents 71, a company key performance indictor 72, and other key performance indicators 73.

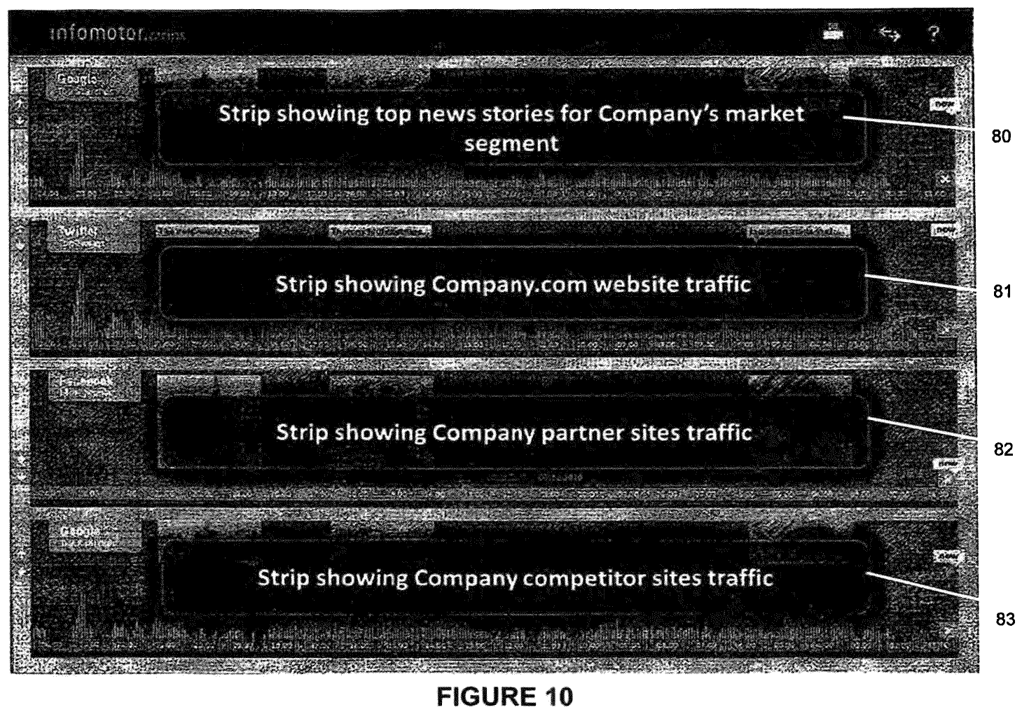

FIG. 10 is a schematic representation of a use case for company-related Web analytics. In FIG. 10, strips are provided that show top news stories for a company's market segment 80, company website traffic 81, company partner website traffic 82, and company competitor website traffic 83.

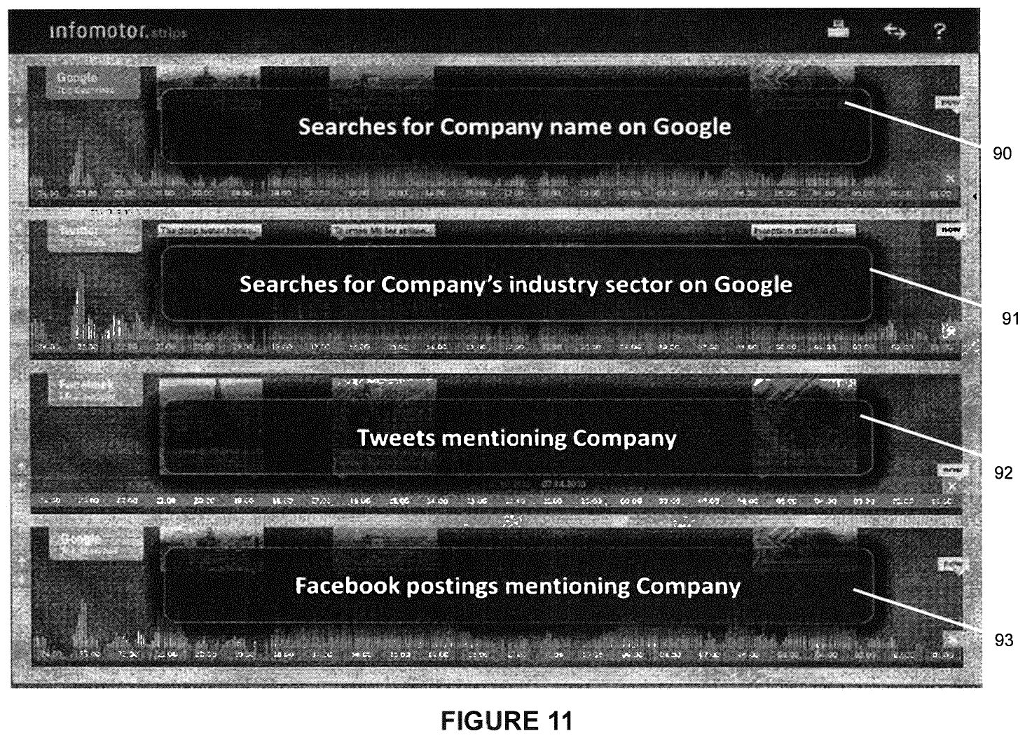

FIG. 11 is a schematic representation of a use case for company-related activity from public data sources. In FIG. 11, strips are provided that show search for the company name on Google® 90, searches for the company's industry sector on Google® 91, tweets that mention the company 92, and Facebook® postings that mention the company.

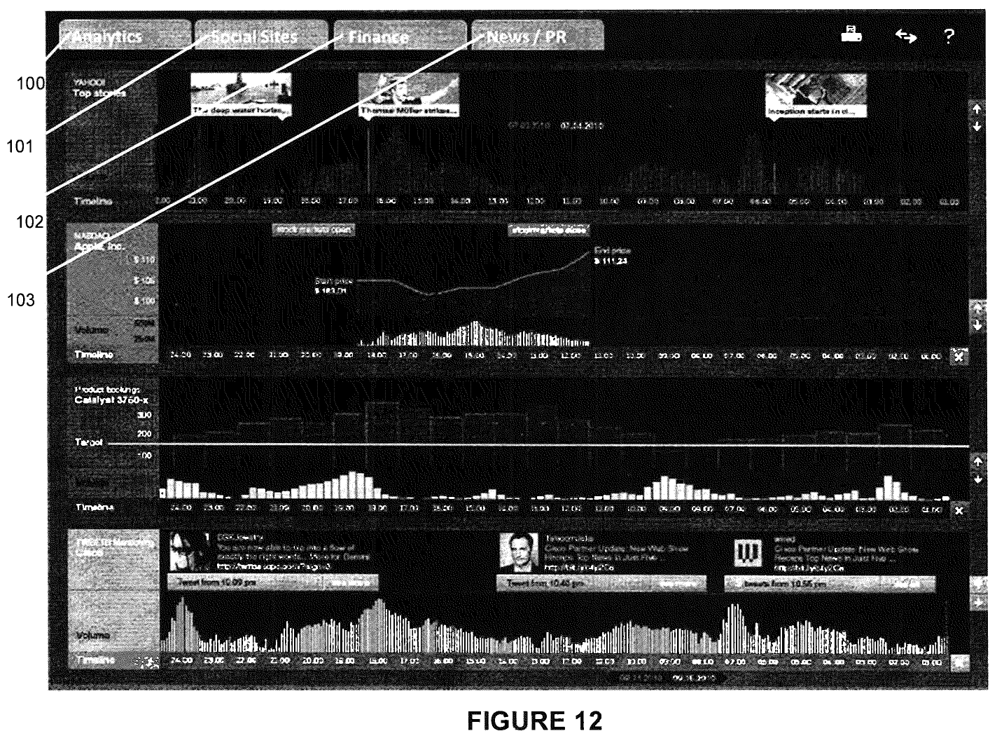

FIG. 12 is a schematic representation that shows dynamic screens of strips grouped under tabs. In FIG. 12, tabs are provided for analytics 100, social sites 101, finance 102, and news/public relations 103.

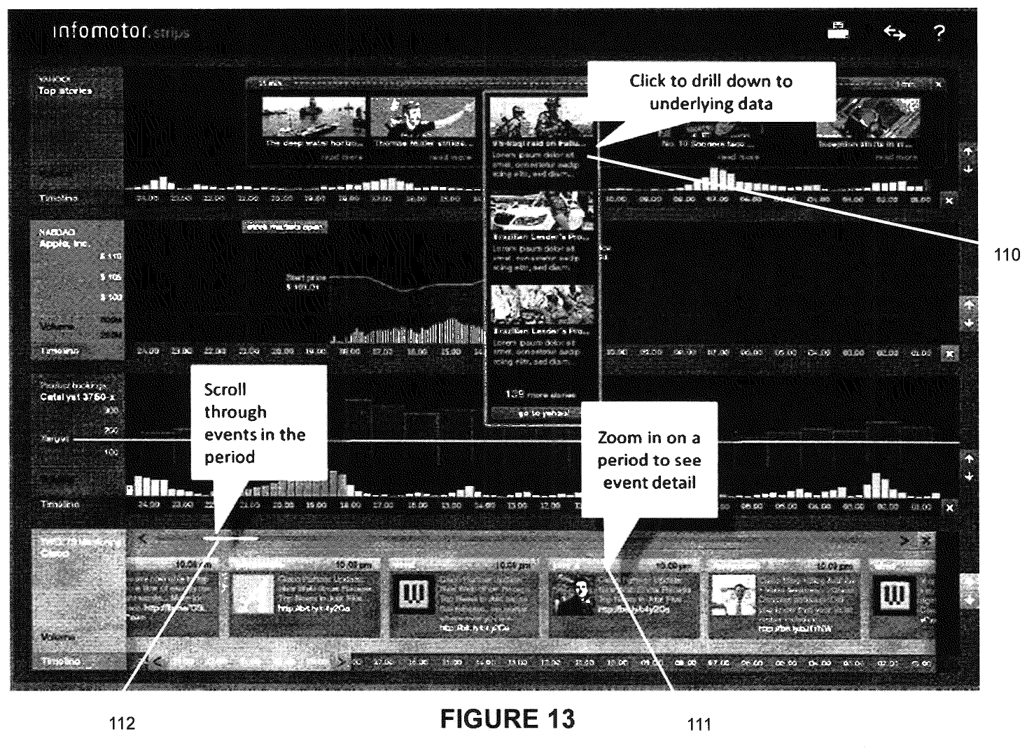

FIG. 13 is a schematic representation that shows navigation, including a button or region 110 that is clicked to drill down to underlying data; a button or region 111 that is clicked to zoom in on a period to see event details; and a scroll function 112 to scroll through events in a time period.

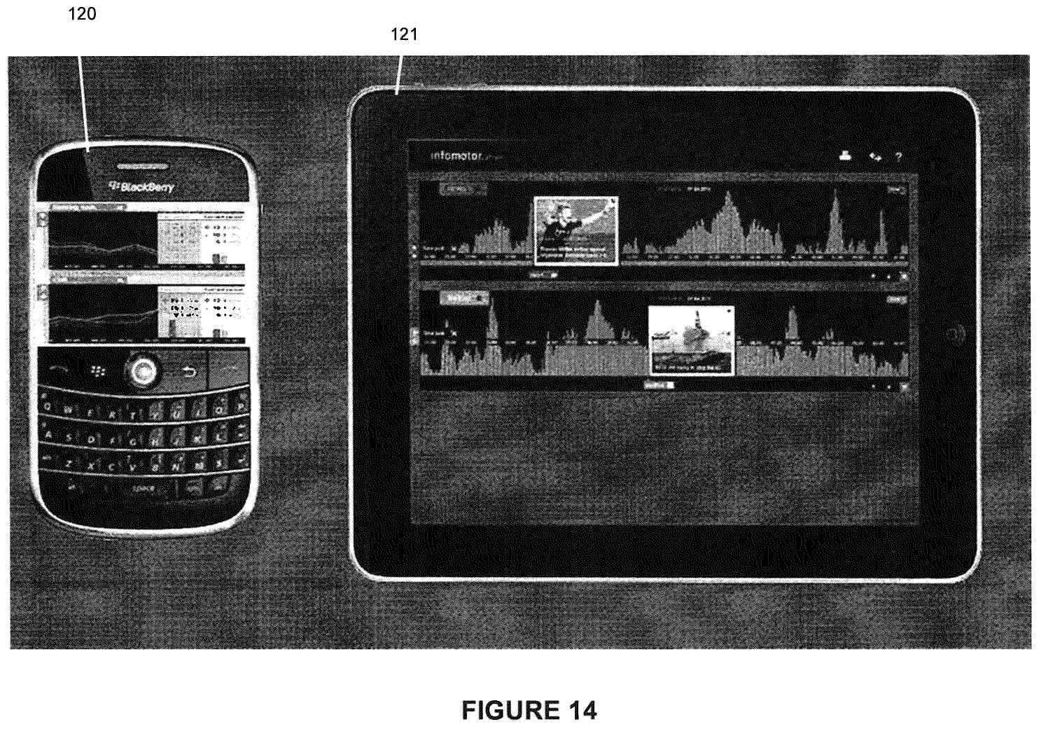

FIG. 14 is a schematic representation which shows that strips are cross platform. In FIG. 14, strips are shown displayed on a handheld device 120 and a tablet device 121. However, strips can also be displayed on any other device, such as a desktop or laptop computer, a television, via a projector, a data ticker, and the like.

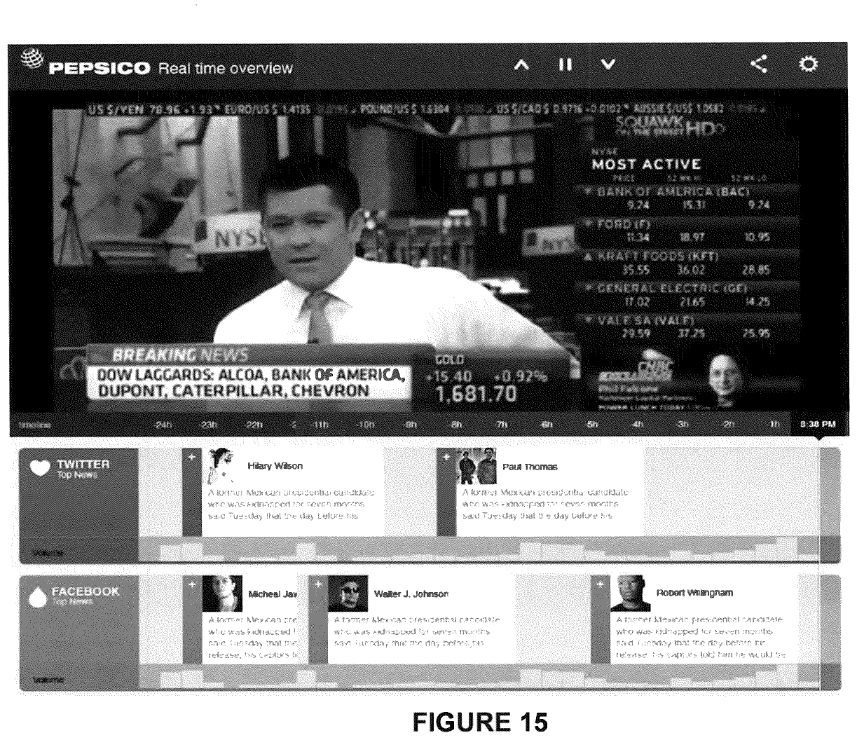

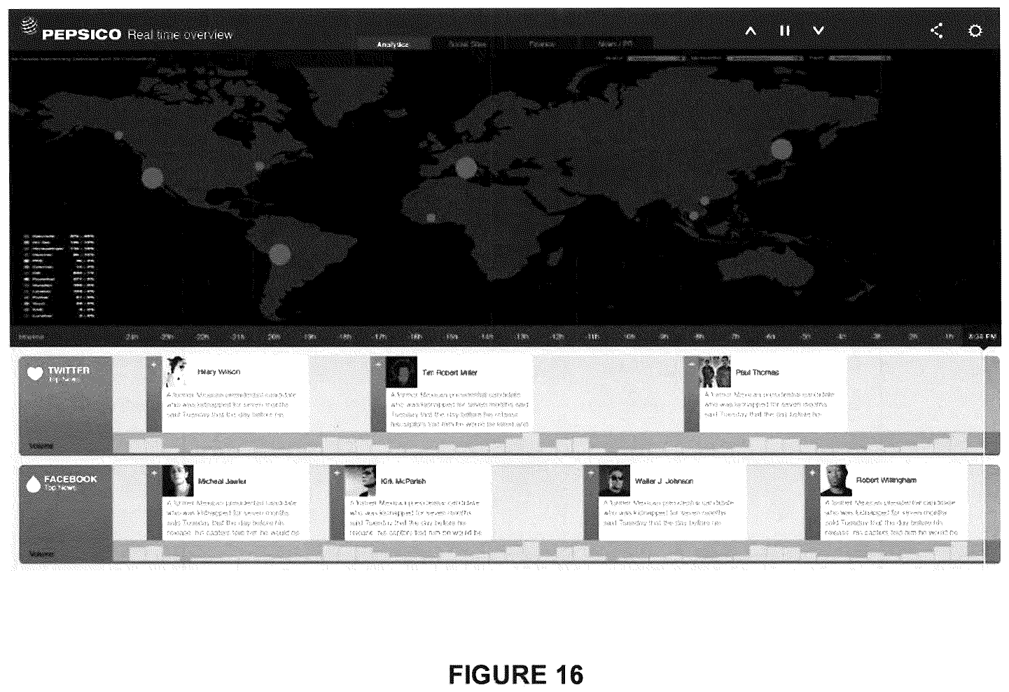

FIGS. 15 and 16 are schematic representations of a widget window. A widget window is a flexible window that displays strip data using an alternative metaphor, for example on a newscast video (FIG. 15) or on a map (FIG. 16). The strips display the data using a timeline metaphor and the map, for example, adds a geographic component to the display, showing where the events occur. It should be appreciated by those skilled in the art that any visual metaphor can be used in this embodiment, For example, one can show video clips in the window that relate to/are driven by the strip timeline content, such as a business newscast, as shown on FIG. 15.

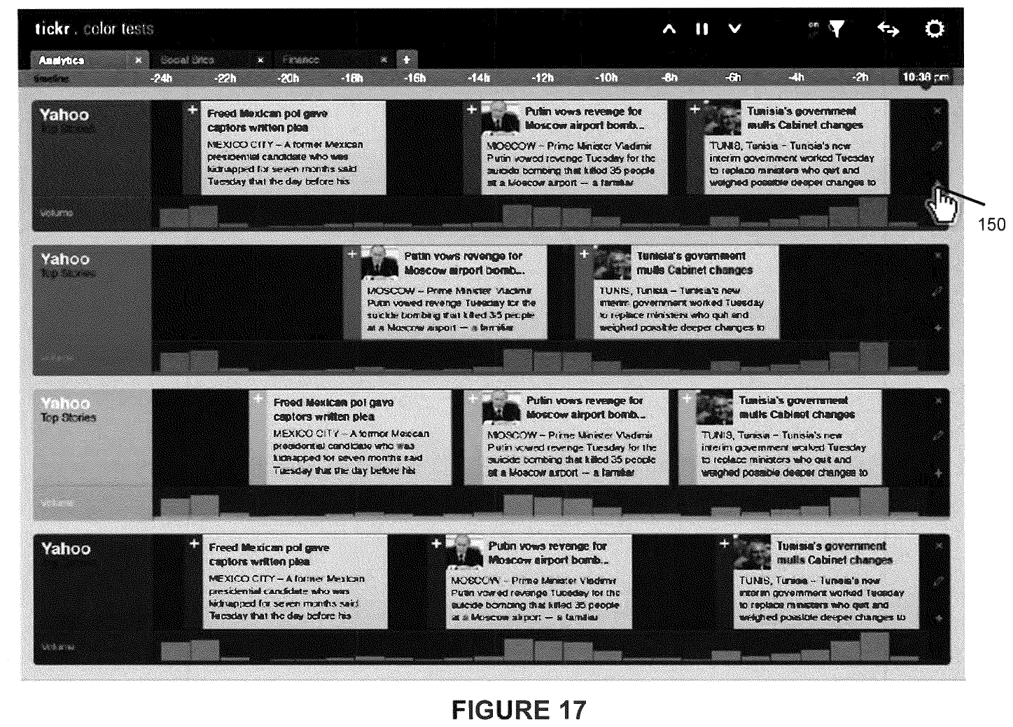

FIGS. 17-21 are a series of screen shots that schematically represent various user operations in connection with the invention disclosed herein.

FIG. 17 is a schematic representation that shows user settings for strips. In the example of FIG. 17, a user selects a + symbol 150 to add a strip to the display.

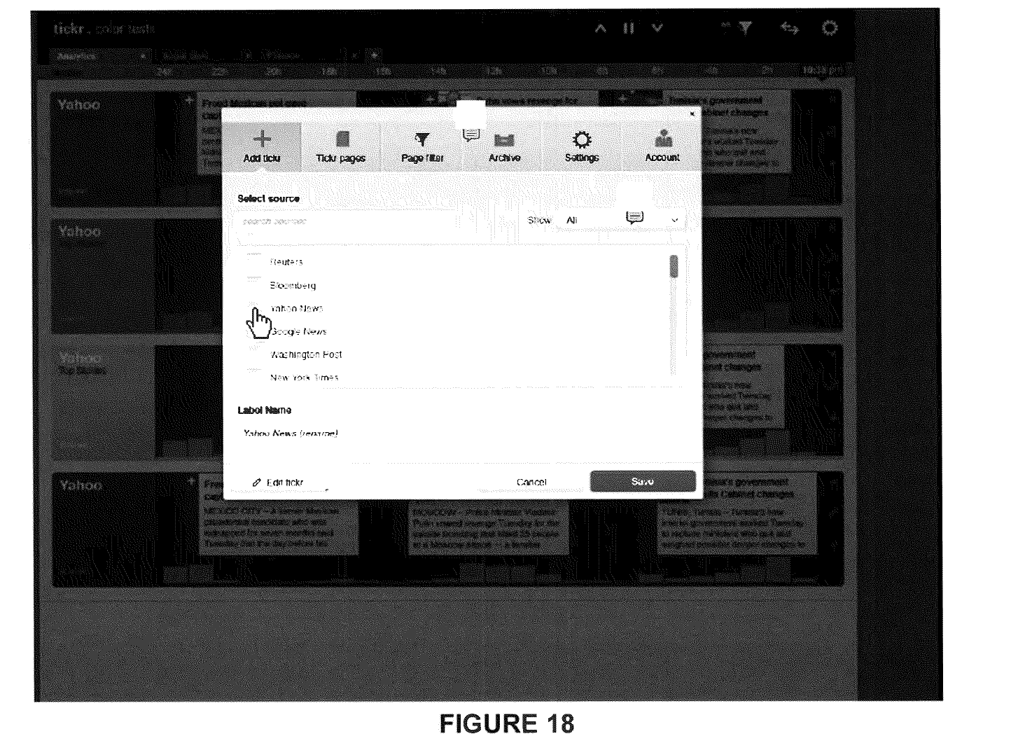

FIG. 18 is a schematic representation that shows a selection for adding a strip.

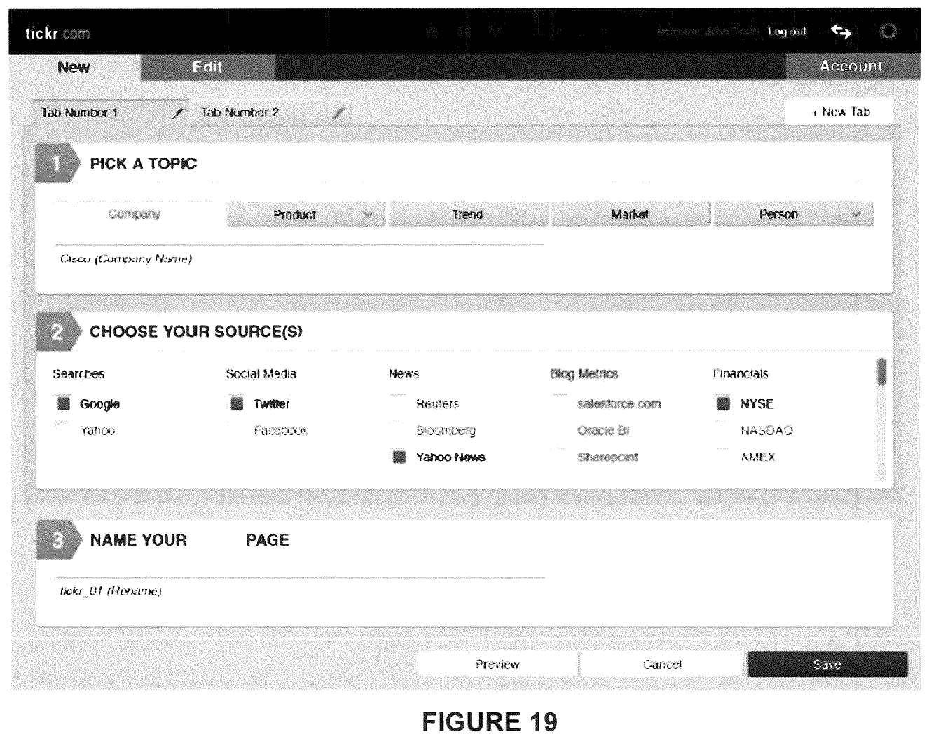

FIG. 19 is a schematic representation of a user dialog for the creation of a strip. In FIG. 19, the user is directed to PICK A TOPIC, CHOOSE YOUR SOURCE(S), and NAME YOUR PAGE. When the user selects SAVE, the strip is created.

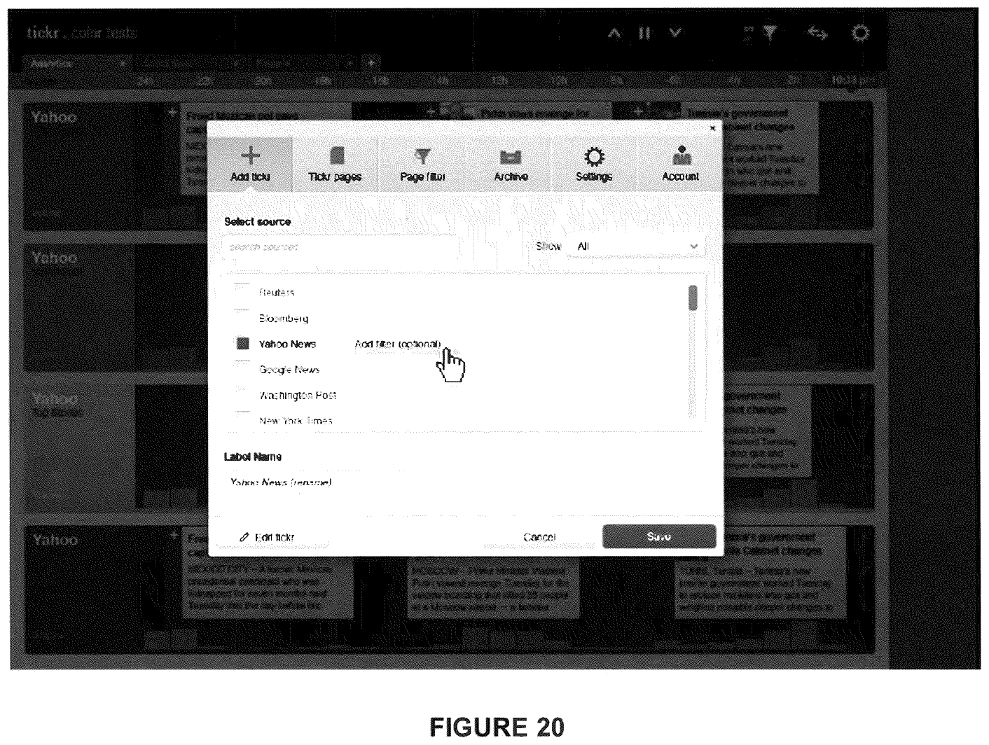

FIG. 20 is a schematic representation that shows user settings for adding a filter to a strip. Filters are used in a variety of ways. For example, a filter can be invoked to compare two temporal data sets quickly, where one data set is filtered and one data set is unfiltered. One data set might show all stock trades made in the last 24 hours and another filtered data set might show only those stock trades where the price per share was $20 or less. Strips enable dynamic creation and adjustment of filters for quick visual and programmatic comparison of filtered and unfiltered data in the temporal domain.

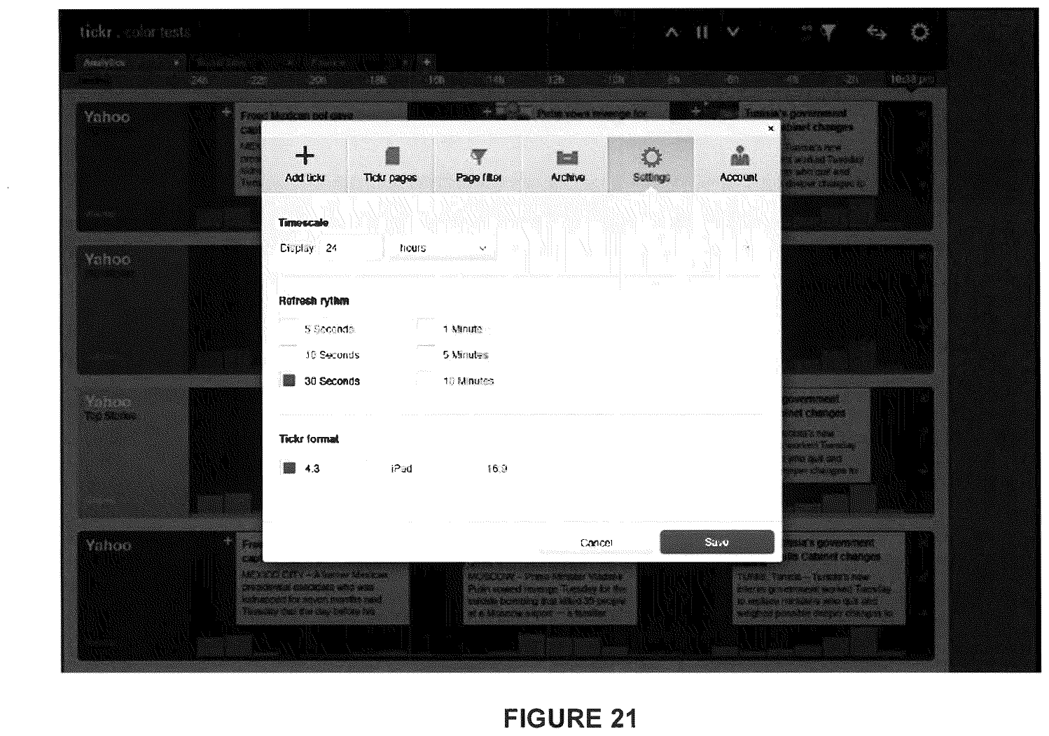

FIG. 21 is a schematic representation that shows user settings for strips.

### Architecture

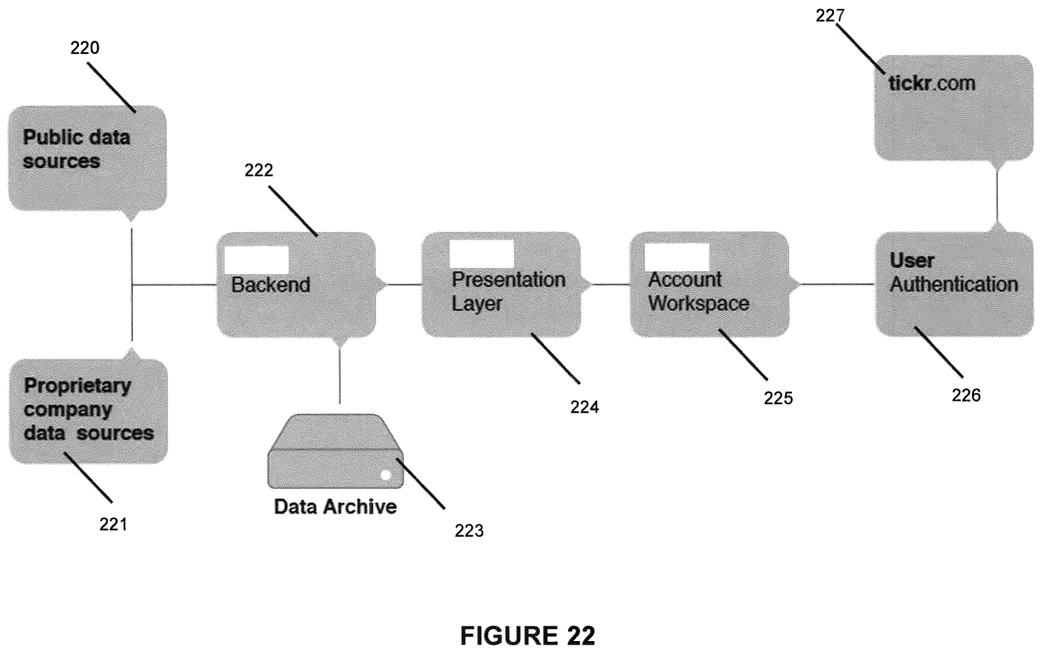

FIG. 22 is a block schematic diagram of an architecture for implementing a presently preferred embodiment of the invention. In FIG. 22, public data sources 220 and proprietary company data sources 221 are made available to the system via a backend facility 222. Information is stored in a data archive 223. The information is assembled for a user in a presentation layer 224 and operated upon in an account workspace 225, subject to user authentication 226. User access is via a Web portal 227 in this embodiment, e.g. tickr.com.

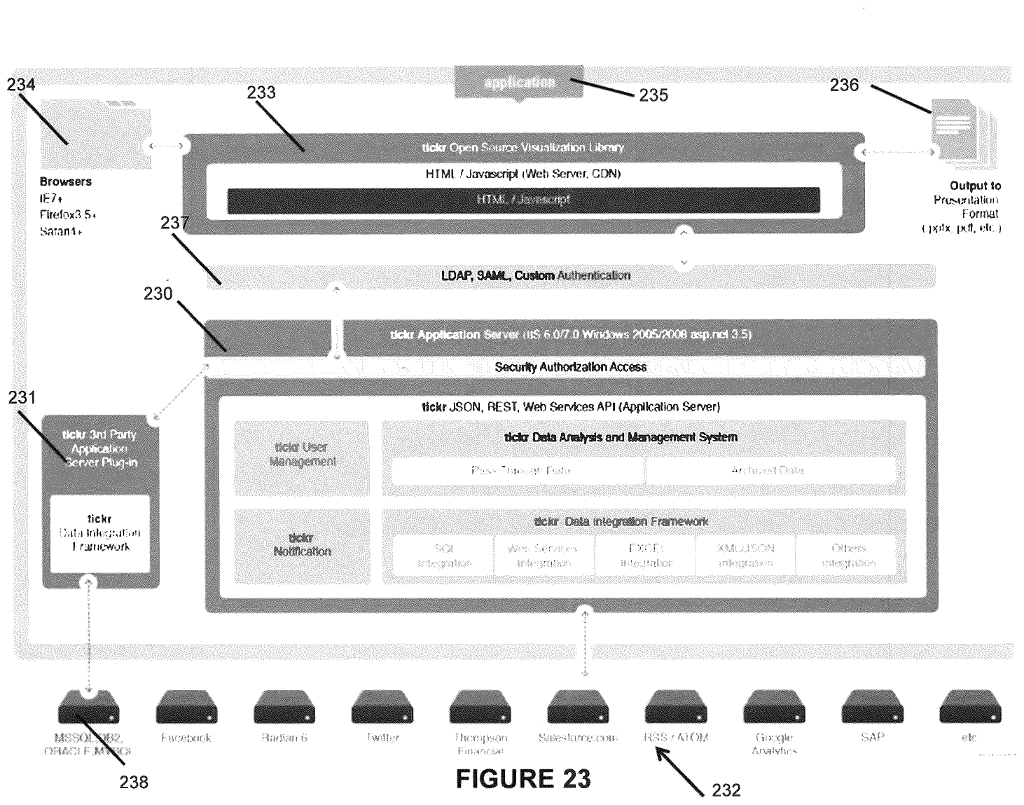

FIG. 23 is a more detailed block schematic diagram of an architecture for implementing a presently preferred embodiment of the invention. In FIG. 23, an application server 230 receives information from a plurality of public information sources 232 and/or, via a third party application server plug-in 231, from private information sources 238. A user accesses this information and operates a UI via a user browser 234 running an application 235, such as a script 233. The script also handles output 236 for presentation to the user. A communications layer 237, for example providing LDAP, SAML, and authentication services, handles the exchange of information between the user end of the system and the application server.

The script 233 comprises an open source visualization library that provides HTML/Javascript.

The application server 230 comprises a security authorization facility. An API provides access to user management functions and notification functions. A data analysis and management system handles pass through data and archived data, while a data integration framework provides SQL integration, web services integration, ECEL integration, XML/JSON integration, and other integration. The data integration places data from all sources into a common format along a common scale. This allows presentation of multiple strips on a display in a meaningful fashion.

Data is harmonized for integration by subjecting it to a variety of normalizing operations. For example, volumetric, spatial, and/or temporal operations may be applied to data. Normalized data is created which enables meaningful comparison, analysis, and discovery of trends and anomalies within the strips environment and also through the use of third party analytics tools, such as SAS and Teradata.

Data for multiple strips can be stored in a common data warehouse. Links between strips are created based on pattern recognition or tags embedded in the data which enable one strip to detect related data in another strip, so that strips reconfigure themselves automatically to show related data in adjacent strips.

### Computer Implementation

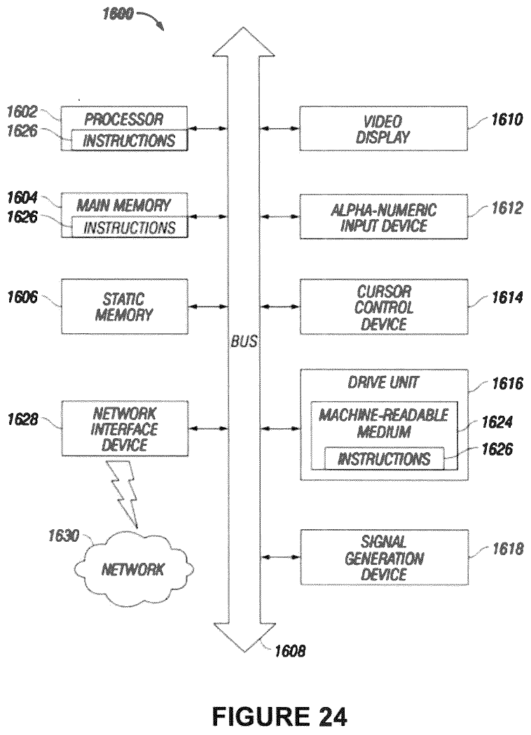

FIG. 24 is a block schematic diagram of a machine in the exemplary form of a computer system 1600 within which a set of instructions for causing the machine to perform any one of the foregoing methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with complementary metal oxide semiconductor (CMOS), transistor-transistor logic (TTL), very large systems integration (VLSI), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method of organizing time-varying information that is related to a company and is acquired from multiple sources, the method comprising:
receiving, via a network-accessible interface, first input indicative of selections of the multiple sources;
receiving, via the network-accessible interface, second input indicative of selections of multiple preconfigured templates; and
for each of the multiple sources,
automatically presenting a corresponding portion of the time-varying information in accordance with a corresponding one of the multiple preconfigured templates, so as to create a multi-dimensional visualization for the company,
wherein the multiple preconfigured templates, with the time-varying information populated therein, are temporally aligned along a common timeline.

2. The method of claim 1, further comprising:
archiving at least some of the time-varying information in a computer server.

3. The method of claim 2, wherein the multiple preconfigured templates are updated in real time as additional time-varying information is acquired from the multiple sources, and wherein said archiving permits a user to perform analysis of past time-varying information related to past events by interacting with the multiple preconfigured templates.

4. The method of claim 3, wherein the user is further permitted to perform analysis of future events by interacting with the multiple preconfigured templates.

5. The method of claim 1, further comprising:
receiving third input indicative of a threshold defined for a given one of the multiple preconfigured templates;
for the given preconfigured template,
comparing the corresponding portion of the time-varying information to the threshold in an ongoing manner; and
automatically dispatching a notification in response to a determination that the threshold has been reached or exceeded.

6. The method of claim 5, wherein the notification is a machine-readable message that prompts a machine event.

7. The method of claim 5, wherein the notification is a human-readable message that serves as an alert for a recipient.

8. The method of claim 1, further comprising:
determining that a first one of the multiple preconfigured templates is related to a second one of the multiple preconfigured templates based on recognition of a pattern in the corresponding portions of the time-varying information represented by the first and second preconfigured templates; and
automatically reconfiguring the multi-dimensional visualization such that the first and second preconfigured templates are adjacent to each other.

9. The method of claim 1, further comprising:
determining that a first one of the multiple preconfigured templates is related to a second one of the multiple preconfigured templates based on tags embedded in the corresponding portions of the time-varying information represented by the first and second preconfigured templates; and
automatically reconfiguring the multi-dimensional visualization such that the first and second preconfigured templates are adjacent to each other.

10. The method of claim 1, further comprising:
receiving third input indicative of a selection of a given one of the multiple preconfigured templates,
wherein the given preconfigured template is associated with a given one of the multiple sources; and
presenting, in response to receiving the third input, more detailed data related to, or acquired from, the given source on the network-accessible interface.

11. The method of claim 1, further comprising:
receiving third input indicative of a selection of a given one of the multiple preconfigured templates,
wherein the given preconfigured template is associated with a given one of the multiple sources; and
establishing, in response to receiving the third input, a two-way link to the given source.

12. The method of claim 1, wherein a timescale of the multi-dimensional visualization is adjustable in real time, so as to permit a user to perform comparisons of events represented across different ones of the multiple preconfigured templates.

13. The method of claim 1, wherein each of the multiple preconfigured templates is a time-based graph.

14. A method of organizing time-varying information that is related to a company and is acquired from multiple sources, the method comprising:
for each of the multiple sources,
presenting a corresponding portion of the time-varying information in accordance with a corresponding one of multiple preconfigured templates, so as to create a multi-dimensional visualization for the company,
wherein the multiple preconfigured templates, with the time-varying information populated therein, are temporally aligned along a common timeline;
determining that a first one of the multiple preconfigured templates is related to a second one of the multiple preconfigured templates; and
automatically reconfiguring the multi-dimensional visualization such that the first and second preconfigured templates are adjacent to each other.

15. The method of claim 14, wherein the first and second preconfigured templates are determined to be related to each other based on recognition of a pattern in the corresponding portions of the time-varying information represented by the first and second preconfigured templates.

16. The method of claim 14, wherein the first and second preconfigured templates are determined to be related to each other based on tags embedded in the corresponding portions of the time-varying information represented by the first and second preconfigured templates.

17. The method of claim 14, further comprising:
receiving first input indicative of a sharing privilege that is specified by a user.

18. The method of claim 17, further comprising:
receiving second input indicative of a request, from the user, to share the multi-dimensional visualization with a second user; and
transmitting, in response to receiving the second input, a Uniform Resource Locator (URL) that complies with the sharing privilege and that, upon being selected, directs a recipient to the multi-dimensional visualization.

19. The method of claim 14, further comprising:
receiving first input indicative of a criterion that is specified by a user; and
completing a search for the time-varying information, if any, that satisfied the criterion.

20. The method of claim 19, wherein the criterion is a keyword, a data pattern, a data threshold, or an interval of time.
